(19) United States
(12) Patent Application Publication
(10) Pub. No.: US 2025/0234176 A1
(43) Pub. Date: Jul. 17, 2025

(54) METHOD FOR TRANSMITTING AN EMERGENCY MESSAGE AND ELECTRONIC DEVICE

(71) Applicant: MediaTek Singapore Pte. Ltd., Singapore (SG)

(72) Inventors: Wen TANG, Beijing (CN); Mi TANG, Beijing (CN); Yajun LI, Beijing (CN)

(21) Appl. No.: 19/016,122

(22) Filed: Jan. 10, 2025

(30) Foreign Application Priority Data
Jan. 16, 2024 (CN) 202410065663.5

(51) Int. Cl. H04W 4/90; H04W 28/02; H04W 74/0836; H04W 76/27

(52) U.S. Cl. CPC H04W 4/90; H04W 28/0278; H04W 74/0836; H04W 76/27

(57) ABSTRACT

A method for transmitting an emergency message is provided. The method includes performing a 2-step random access procedure via a first user device (UE). The method further includes transmitting a first uplink message in the 2-step random access procedure to a base station via the first UE. The first uplink message includes a preamble and a payload, and the payload includes an emergency indicator. The emergency indicator instructs the base station to inform a core network to transmit an emergency message to a second UE or a rescue center.

### CROSS REFERENCE TO RELATED APPLICATIONS

This Application claims priority of China Patent Application No. 202410065663.5, filed on Jan. 16, 2024, the entirety of which is incorporated by reference herein.

### BACKGROUND OF THE INVENTION

### Field of the Invention

The present invention relates to wireless communication, and, in particular, to methods for transmitting an emergency message.

### Description of the Related Art

When the user is in danger and has to transmit an emergency message to ask for help, there's usually only a short period of time to send an emergency message. Furthermore, the user is usually in a tough communication environment. For example, the user may be in the wild or in a crowded place, and the communication device may be broken, or the remaining battery power of the communication device may be low, or it may be hard to connect to a network. Thus, how to successfully transmit an emergency message quickly even in a tough communication environment is an issue that needs to be solved.

### BRIEF SUMMARY OF THE INVENTION

An embodiment of the present invention provides a method for transmitting an emergency message. The method comprises performing a 2-step random access procedure via a first user device (UE). The method further comprises transmitting a first uplink message in the 2-step random access procedure to a base station via the first UE. The first uplink message comprises a preamble and a payload, and the payload comprises an emergency indicator. The emergency indicator instructs the base station to inform a core network to transmit an emergency message to a second UE and/or a rescue center.

An embodiment of the present invention provides an electronic device, which acts as a first UE. The electronic device comprises a transceiver and a processing circuit. The processing circuit is configured to perform a 2-step random access procedure. The processing circuit is further configured to transmit a first uplink message in the 2-step random access procedure to a base station through the transceiver. The first uplink message comprises a preamble and a payload, and the payload comprises an emergency indicator. The emergency indicator instructs the base station to inform a core network to transmit an emergency message to a second UE and/or a rescue center.

### BRIEF DESCRIPTION OF THE DRAWINGS

The present invention can be more fully understood by reading the subsequent detailed description and examples with references made to the accompanying drawings, wherein:

FIG. 1 is a schematic diagram of a communication system 10 in accordance to the embodiments of the present disclosure;

FIG. 2 is a block diagram of the electronic device in accordance to the embodiments of the present disclosure;

FIG. 3 is a schematic diagram of a method for transmitting an emergency message;

FIG. 4 is a schematic diagram of a method for transmitting an emergency message;

FIGS. 5A and 5B are schematic diagrams of methods for transmitting an emergency message; and

FIG. 6 is a flow diagram of a method for transmitting the emergency message.

### DETAILED DESCRIPTION OF THE INVENTION

The following description is made for the purpose of illustrating the general principles of the invention and should not be taken in a limiting sense. The scope of the invention is best determined by reference to the appended claims.

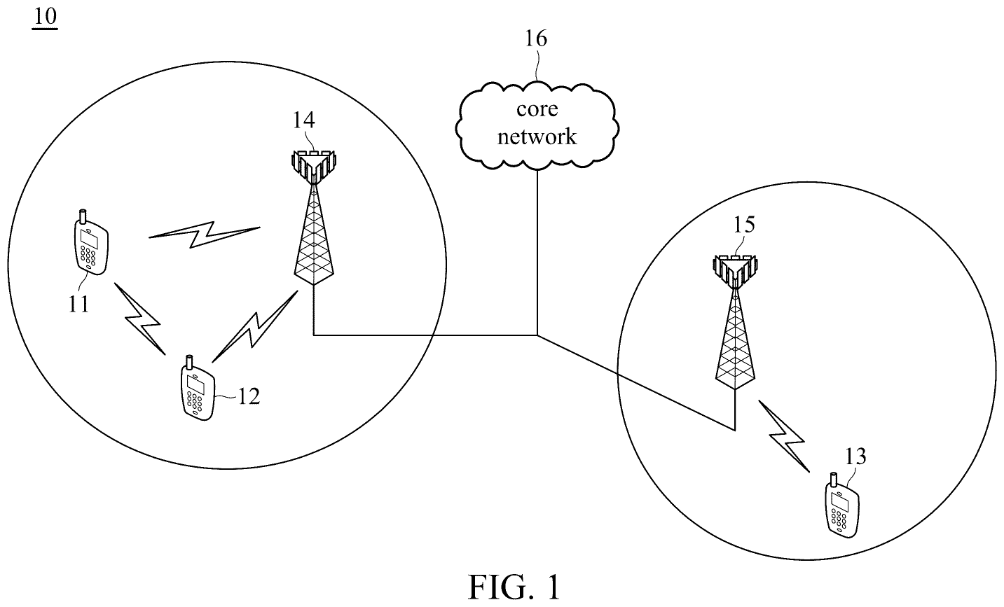

FIG. 1 is a schematic diagram of a communication system 10 in accordance to the embodiments of the present disclosure. As shown in FIG. 1, the communication system 10 may include user equipment (UE) 11, 12, 13, a base station 14, 15, and a core network 16. The UE 11 may wirelessly connect to the base station 14, and UE 13 may wirelessly connect to the base station 15. UE 13 and 15 may therefore communicate with each other. Alternatively, UE 11 may wirelessly connect to UE 12, and UE 12 may wirelessly connect to the base station 14. In this case, UE 11 connects to the base station 14 through the UE 12, and UE 12 may be referred to as a relay UE. The base stations 14 and 15 may be access points, access terminals, evolved Node-Bs (eNBs), or gNodeBs (gNBs), or satellites. The base stations 14 and 15 provide wireless communication to UE 11, 12, 13. For example, the base stations 14 and 15 may be responsible for processing radio signals, terminating radio protocols, and connecting the UE 11 with the core networks 16. The core network 16 is responsible for performing mobility management, network-side authentication, and interfaces with public/external networks (e.g., the Internet). It should be understood that the communication system 10 described in the embodiment of FIG. 1 is for illustrative purposes only and are not intended to limit the scope of the application.

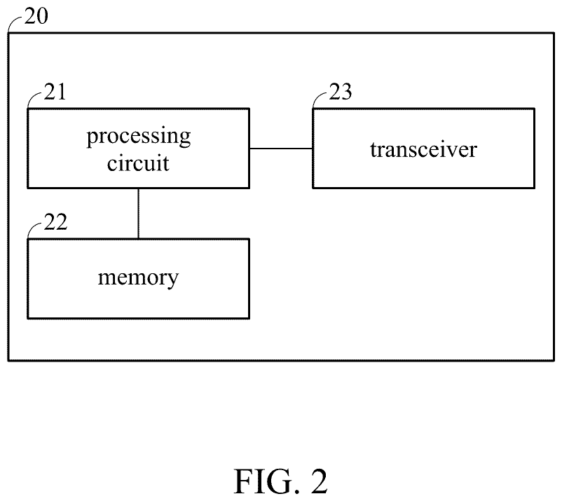

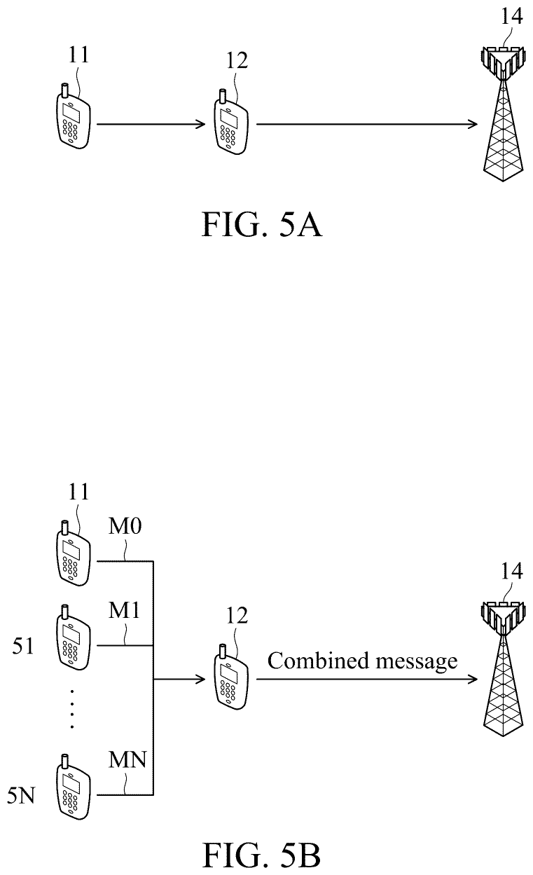

FIG. 2 is a block diagram of the electronic device 20 in accordance to the embodiments of the present disclosure. The electronic device 20 may perform various functions to implement processes and methods described herein. The electronic device 20 may act as a UE or be a part of a UE, such as UE 11, 12, 13 in the FIG. 1 or the UE 51˜5N in FIG. 5B. The electronic device 20 may be a mobile apparatus, a wearable apparatus, a wireless communication apparatus, or a computing apparatus. For example, the electronic device 20 may be a feature phone, a smartphone, a tablet computer, a smart watch, or a laptop computer. The electronic device 20 includes a processing circuit 21, a memory 22, and a transceiver 23.

The processing circuit 21 controls operations of the electronic device 20. The processing circuit 21 provides the required process ability to perform operating systems, programs, software, modules, applications, and functions of the electronic device 20. The processing circuit 21 may be implemented in the form of one or more integrated-circuit (IC) chips such as, one or more processors. The processing circuit 21 may be implemented in the form of hardware with electronic components including transistors, diodes, capacitors, resistors, or inductors. These components are configured and arranged to achieve specific purposes in accordance with the present disclosure. In other words, the processing circuit 21 is a special-purpose machine specifically configured to perform specific tasks including method of the present disclosure. For example, the processing circuit 21 may be a general purpose micro-processor, a central processing unit, the combination of the general purpose processor and special purpose processor, and/or related chip set.

The memory 22 stores data required by the processing circuit 21. The memory 22 may include non-volatile memories, such as read only memory (ROM) and flash memory. The memory 22 may also include volatile memories, such as dynamic random access memory (DRAM) and static random access memory (SRAM). In some embodiments, the memory 22 stores a program (e.g. computer-readable instruction). The program can be operated by the processing circuit 21. When the program is operated by the processing circuit 21, the program causes the processing circuit 21 to implement methods according to the embodiments of the present disclosure.

The transceiver 23 is capable to transmit and receive data wirelessly. The transceiver 23 is coupled with one or more antennas. The transceiver 23 receives radio frequency (RF) signals from the antenna and converts RF signals to baseband signals. The transceiver 23 also converts the baseband signals to the RF signals and sends out the RF signals through the antenna.

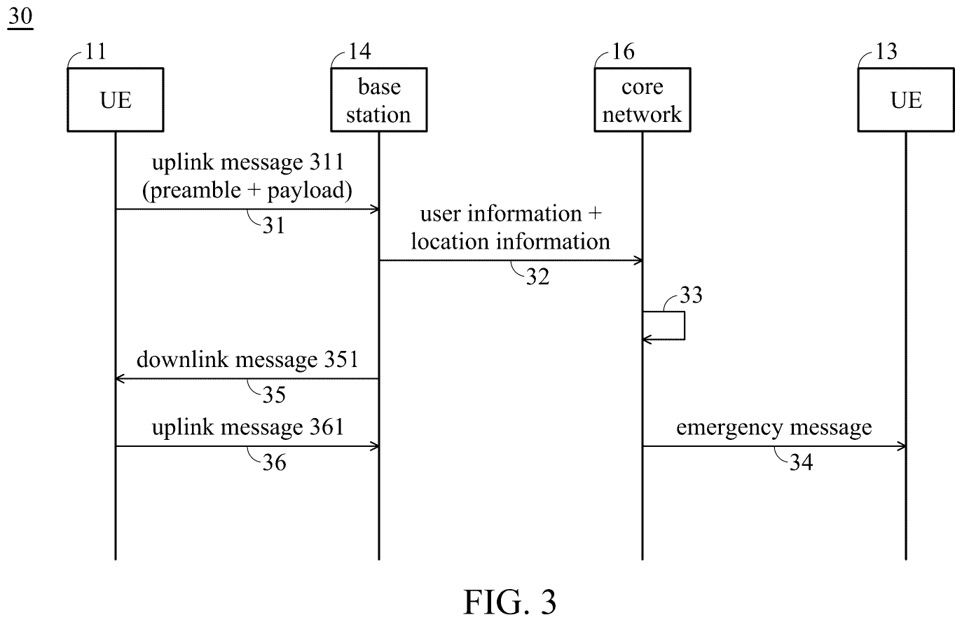

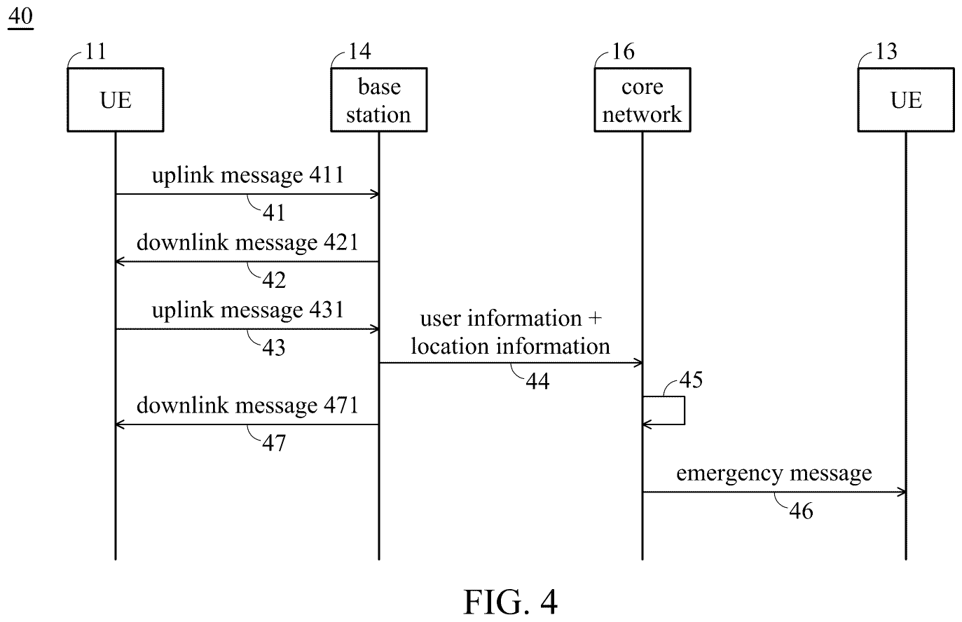

Refer to FIG. 1, FIG. 2, and FIG. 3. FIG. 3 is a schematic diagram of a method 30 for transmitting an emergency message. The following takes UE 11, 13, base station 14, and core network 16 as example to illustrate method 30. In operation 31, the processing circuit 21 of the UE 11 performs a 2-step random access procedure. The processing circuit 21 of the UE 11 transmits an uplink message 311 (e.g. a first uplink message) in the 2-step random access procedure to the base station 14 through the transceiver 23. The uplink message 311 comprises a preamble and a payload. The payload comprises an emergency indicator. In some embodiments, the emergency indicator may be 1-bit indicator. In some embodiments, the UE 11 is in an RRC_IDLE state and/or in an RRC_Connected state and/or in an RRC_Inactive state. In some embodiments, the UE 11 executes method 30 in the RRC_Connected state or the RRC_Inactive state, when the base station 14 doesn't allocate resource for the method 40 or the method 40 was failed. The emergency indicator instructs the base station 14 to inform the core network 16 to transmit an emergency message to the UE 13. In some embodiments, the payload may further comprise the user information of the UE 11, the location information, or both. The user information of the UE 11 allows the base station 14 and the core network 16 to identify the identity of the UE 11. For example, the user information may be identification information, a subscriber identity module (SIM) ID, or a dynamic authentication code generated by the UE 11. The location information indicates the current location of the UE 11. For example, the location information may be the coordinates of the UE 11 as determined by the global positioning system. In some embodiments, the location information includes current cell information of the UE 11, one or more historical location information of the UE 11, or the information of the network that the UE 11 has camped on, in response to the uplink message 431 (Refer to FIG. 4) or the payload of the uplink message 311 not comprising location information. In some embodiments, the UE 11 may transmit the uplink message 311 many times.

In operation 32, the base station 14 transmits the user information of the UE 11 and the location information to the core network 16. In some embodiments, the emergency indicator instructs the base station 14 to transmit the user information of the UE 11 and the location information to the core network 16. In operation 33, the core network 16 transform the received location information into the location information that is recognizable by the human. In some embodiments, the core network 16 transforms the received location information, which may be the raw data, into a text representing an address, or a place name.

In operation 34, the core network 16 transmits an emergency message to the UE 13. The emergency message comprises the location information, the distress message, or both. The location information may be the transformed location information. The distress message may be a text, such as “SOS” or “mayday”.

In some embodiments, the core network 16 receives the identity of the UE 13 and the distress message before the UE 11 transmits the uplink message 311. In some embodiments, before performing the aforementioned operations, the UE 11 informs the core network 16 the identity of the UE 13 and the distress message, so as to set UE 13 as an emergency contact. This may be done in a situation that the UE 11 is in a steady communication environment. In some embodiments, the processing circuit 21 of the UE 11 transmits the user information of the UE 13 (such as the SIM ID) and the distress message to the core network 16 through the transceiver 23, before transmitting the uplink message 311. In some embodiments, core network 16 may receive the identity of the UE 13 and the distress message from the computer connected to the core network 16. The user may input the identity of the UE 13 and the distress message to the computer connected to the core network 16. The core network 16 stores the user information of the UE 13 and the distress message. The core network 16 also associates the UE 11 with the user information of the UE 13 and the distress message. Thus, in operation 34, the core network 16 determines to transmit the emergency message to the UE 13 based on the user information of the UE 11. In some embodiments, there may be a plurality of pre-defined distress messages stored in the core network 16. Each of these pre-defined distress messages has an unique number. The payload may further comprise the indication (e.g. the number) of pre-defined distress message, so as to indicate the core network 16 to transmit the selected pre-defined distress message in the emergency message.

In other embodiments, the UE 11 doesn't inform the core network 16 the identity of the UE 13 and the distress message before transmitting the uplink message 311. Instead, the payload further comprises the user information of the UE 13 and/or the distress message. In operation 34, the core network 16 determines to transmit the emergency message to the UE 13 based on the user information of the UE 13 in the payload.

In a selective operation 35, the processing circuit 21 of the UE 11 receives a downlink message 351 (e.g. the first downlink message) from the base station 14 through the transceiver 23. In some embodiments, the downlink message 351 comprises a resource configuration for retransmitting the uplink message 311, an acknowledgement message (ACK) of the uplink message 311, the evacuation guidance, or all. The acknowledgement message of the uplink message 311 acknowledges reception of the uplink message 311. When the payload of the uplink message 311 doesn't comprise the user information of the UE 11 or the location information, the downlink message 351 may further comprise a resource configuration for transmitting an uplink message 361 (e.g. the second uplink message). Then, in a selective operation 36, the processing circuit 21 of the UE 11 transmits the uplink message 361 to the base station 14 through the transceiver 23, when the downlink message 351 comprises the resource configuration for transmitting the uplink message 361. The uplink message 361 comprises the user information of the UE 11 and/or the location information. Operation 35 and 36 may be skipped. Operation 36 may be performed when the payload of the uplink message 311 doesn't comprise the user information of the UE 11 or the location information. Furthermore, operation 32 may be performed before/after the operation 35.

In some embodiments, the processing circuit 21 of the UE 11 performs an application to implement method 30. In some embodiments, the UE 11 performs the operation 31 in response to the user touching a button generated by the application. The user information may be the authentication code generated by the application. In some embodiments, the base station 14 and the core network 16 perform applications to implement method 30. The above mentioned operations may be implemented by different applications of the UE 11, base station 14, and the core network 16. The above mentioned operations may be implemented by different functions of the application of the UE 11, base station 14, and the core network 16. The above mentioned operations may have more than one emergency contacts.

Method 30 allows UE to transmit the message to ask for help in a 2-step random access procedure. In the original 2-step random access procedure, the UE has to transmit MsgA to the base station, and MsgA comprises a preamble and a payload. Embodiments of the present disclosure may replace the payload of MsgA and use the payload to transmit the emergency indicator, the user information, and the location information, so as to transmit the message to ask for help. The emergency indicator instructs the base station or the core network to transmit an emergency message. The uplink message 311 may have the same preamble with MsgA, but have different payload with MsgA. When the UE wants to transmit message to the base station, the UE has to perform the random access procedure so as to connect to the base station. However, in case of emergency, the message needs to be transmitted as soon as possible. Furthermore, it may be hard to connect to the base station. Thus, transmitting the message to ask for help in the random access procedure allows UE to transmit the message before the random access procedure is completed.

The UE in accordance to the embodiments of the present disclosure may also transmit the message for help in the RRC_CONECTED state. Refer to FIG. 1, FIG. 2, and FIG. 4. FIG. 4 is a schematic diagram of a method 40 for transmitting an emergency message. The following takes UE 11, 13, base station 14, and core network 16 as example to illustrate method 40. In operation 41, the processing circuit 21 of the UE 11 transmits the uplink message 411 (e.g. the third uplink message) to the base station 14 through the transceiver 23, when the UE 11 is in the RRC_CONNECTED state the RRC_IDLE state, or the RRC_INACTIVE state. In some embodiments, the UE 11 executes method 40 in the RRC_IDLE state or the RRC_INACTIVE state, when the UE 11 is in a geosynchronous orbit (GSO) system. In the GSO system the timing advance is fixed, and the emergency message can be transmitted in the configured PUCCH/PUSCH resources. The uplink message 411 comprises the emergency indicator. In some embodiments, the uplink message 411 further comprises uplink reference signal. In some embodiments, the uplink message 411 is a buffer status report (BSR) carried in a physical uplink control channel (PUCCH).

In operation 42, the processing circuit 21 of the UE 11 receives the downlink message 421 (e.g. the second downlink message) from the base station 14 through the transceiver 23. The downlink message 421 comprises a resource configuration for transmitting the uplink message 431 (e.g. the fourth uplink message) and an acknowledgement message of the uplink message 411. In operation 43, the processing circuit 21 of the UE 11 transmits the uplink message 431 to the base station 14 through the transceiver 23. The uplink message 431 comprises the user information of the UE 11, the location information, or both.

In operation 44, the base station 14 transmits the user information of the UE 11 and the location information to the core network 16. In some embodiments, the emergency indicator instructs the base station 14 to transmit the user information of the UE 11 and the location information to the core network 16. In operation 45, the core network 16 transform the received location information into the location information that is recognizable by the human. In operation 46, the core network 16 transmits an emergency message to the UE 13. The emergency message comprises the location information, the distress message, or both. Operations 44, 45, and 46 may be similar to operations 32, 33, and 34.

In a selective operation 47, the processing circuit 21 of the UE 11 receives the downlink message 471 from the base station 14 through the transceiver 23. The downlink message 471 may comprise the acknowledgement message of the uplink message 431, the indication to retransmit the uplink message 431, or the evacuation guidance. The operation 47 may be performed before/after the operation 44.

In some embodiments, the processing circuit 21 of the UE 11 transmits the user information of the UE 13 and the distress message to the core network 16 through the transceiver 23, before transmitting the uplink message 411. The core network 16 stores the user information of the UE 13 and the distress message. The core network 16 associates the UE 11 with the user information of the UE 13 and the distress message. In operation 46, the core network 16 determines to transmit the emergency message to the UE 13 based on the user information of the UE 11. In other embodiments, UE 11 doesn't transmit the user information of the UE 13 and the distress message before transmitting the uplink message 411, and the uplink message 411 or 431 further comprises the user information of the UE 13 or the distress message.

In some embodiments, the core network 16 transmits the emergency message to a public platform, in response to the uplink message 431 or the payload of the uplink message 311 not comprising the user information of the UE 11. For example, the public platform may be the rescue center, the police station, or the fire station. In some embodiments, the core network 16 may transmit the emergency message to the rescue center and/or the UE 13 no matter whether the uplink message 431 or the payload of the uplink message 311 comprises the user information of the UE 11 or not. In some embodiments, the emergency message comprises current cell information of the UE 11, one or more historical location information of the UE 11, or the information of the network that the UE 11 has camped on, in response to the uplink message 431 or the payload of the uplink message 311 not comprising location information.

In some embodiments, when the UE 11 is in the RRC_CONNECTED state, the processing circuit 21 of the UE 11 may transmit a packet to the base station through the transceiver 23, and the layer 2 header of the packet may comprise the emergency indicator as well as the user information of the UE 11, the location information, or both. The layer 2 header may be the medium access control (MAC) layer header, the radio link control (RLC) layer header, the packet data convergence protocol (PDCP) layer header, or the service data adaptation protocol (SDAP) header. In some embodiments, the emergency indicator (and the user information or the location information) is added into all the layer 2 header. The emergency indicator indicates the base station to simplify or skip at least one message processing operation, to allocate a frequency band dedicated to the packet, to allocate a contention based frequency band to the packet, or to transmit the packet with a higher priority. For example, the emergency indicator may indicate the base station not to demodulate other information after the emergency indicator, the user information, or the location information has already been demodulated. The emergency indicator may indicate the base station to skip the error correction process, the retransmission process, or the identity identification process for the packet.

Refer to FIG. 1, FIG. 2, and FIG. 5A. FIG. 5A is a schematic diagram of a method for transmitting an emergency message. In some embodiments, the UE 11 connects to the UE 12. The processing circuit 21 of the UE 11 transmits a message to the base station 14 through the UE 12 via the transceiver 23. The message comprises the emergency indicator along with the user information of the UE 11, the location information, or both. Then, the base station 14 transmits the message to another UE, such as UE 13. In some embodiments, the UE 11 connects to the UE 12 via Wi-Fi, Wi-Fi direct, Hotspot, Bluetooth, airdrop, CrossMount, or Hotknot. However, embodiments of the present disclosure should not be limited to the aforementioned wireless communication technologies. Embodiments of the present disclosure may apply any proper point-to-point wireless communication technology.

In some embodiments, the UE 12 broadcasts the broadcast message to the neighboring devices. The broadcast message indicates that the UE 12 is able to connect to the terrestrial network (TN) or the non-terrestrial network (NTN). The broadcast message may further indicate that the UE 12 is able to perform the device-to-device communication. The UE 11 may transmit a request to the UE 12 after receiving the broadcast message so as to connect to the UE 12. In other embodiments, the UE 11 broadcasts the broadcast message to the neighboring devices so as to request to connect to other devices. The UE 12, which is able to connect to the TN or NTN, may transmit a response message after receiving the broadcast message. The UE 11 may connect to the UE 12 after receiving the response message. In either embodiment, the UE 12 may have already connected to the TN or NTN when the UE 11 connects to the UE 12. Alternatively, the UE 12 may connect to the TN or NTN in response to that the UE 11 connecting to the UE 12. The broadcast message may be transmitted using non-3GPP access. For example, the non-3GPP access may be Bluetooth, Wi-Fi direct, or Airdrop.

In some embodiments, the UE 11 transmits the message to the base station 14 using the identity of the UE 12. In this embodiment, UE 12 receives the message from UE 11 and transmits the message to the base station 14 using its own identity. In this embodiment, the message may comprise the user information of the UE 11, the distress message, the location information, or the destination of the message. In some embodiments, the UE 11 transmits the message to the base station 14 using the identity of the UE 11. In this embodiment, the UE 11 connects to the base station 14 through the UE 12.

Refer to FIG. 1, FIG. 2, and FIG. 5B. FIG. 5B is a schematic diagram of a method for transmitting an emergency message. The UE 12 receives a plurality of messages from UE 11 and UE 51˜5N and transmits a combined message to the base station 14. As shown in the FIG. 5B, the UE 11 transmits message M0 to the UE 12, the UE 51 transmits message M1 to the UE 12, and the UE 5N transmits message MN to the UE 12. Each of the message M0˜MN comprises the emergency indicator along with the identification information of the UE, the location information, or both. Specifically, message M0 comprises the emergency indicator and either the identification information of the UE 11, the location information of the UE 11, or both. Message M1 comprises the emergency indicator along with the identification information of the UE 51, the location information of the UE 51, or both. Message MN comprises the emergency indicator along with the identification information of the UE 5N, the location information of the UE 5N, or both. The combined message comprises the messages M0˜MN. After receiving the combined message, the base station 14 obtains message M0˜MN from the combined message and respectively transmits message M0˜MN to the different destinations of the message M0˜MN. In some embodiments, UE11, UE 12, UE 13, and UE 51˜5N may belong to the same operator or different operators.

Embodiments described referring to FIG. 5B may combined with embodiments described referring to FIG. 5A. For example, UE 11 and UE 51˜5N may broadcast the broadcast message to the neighboring devices. The broadcast message may comprise a flag which indicates that the UE 11 and UE 51˜5N are requesting to connect to other devices. Alternatively, the UE 12 may broadcast the broadcast message to the neighboring devices to inform other devices the ability to connect to the base station and to perform the device-to-device communication. Furthermore, embodiments described referring to FIGS. 5A and 5B may combined with embodiments described referring to FIGS. 1˜4. For example, UE 11 and UE 50˜5N may perform applications to implement embodiments described referring to FIGS. 5A and 5B. In some embodiments, the UE 11 and UE 50˜5N perform the above mentioned operations in response to the user touching a button generated by the application. The user information may be the authentication code generated by the application. For example, the UE 11 and UE 50˜5N may report the core network the user information of the UE 12 and other UE in advance (e.g. before transmitting the message), and the message may not comprise the destination of the message.

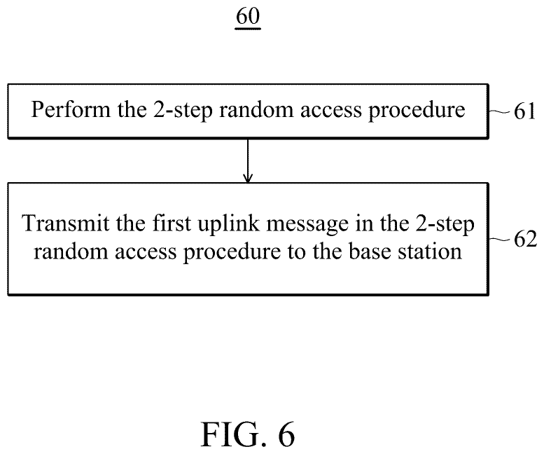

Refer to FIG. 1, FIG. 2, and FIG. 6. FIG. 6 is a flow diagram of a method 60 for transmitting the emergency message. Method 60 may be implemented in communication system 10, UE 11, and electronic device 20. The following takes UE 11, 13, base station 14, and core network 16 as example to illustrate method 60. In operation 61, the processing circuit 21 of the UE 11 performs the 2-step random access procedure. In operation 62, the processing circuit 21 of the UE 11 transmits the first uplink message (e.g. uplink message 311) in the 2-step random access procedure to the base station 14. The first uplink message comprises a preamble and a payload. The payload comprises an emergency indicator. The emergency indicator instructs the base station 14 to inform the core network 16 to transmit an emergency message to the UE 13 and/or a rescue center.

While the invention has been described by way of example and in terms of the preferred embodiments, it should be understood that the invention is not limited to the disclosed embodiments. On the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A method for transmitting an emergency message, comprising:
performing, via a first user device (UE), a 2-step random access procedure; and
transmitting, via the first UE, a first uplink message in the 2-step random access procedure to a base station, wherein the first uplink message comprises a preamble and a payload, wherein the payload comprises an emergency indicator;
wherein the emergency indicator instructs the base station to inform a core network to transmit an emergency message to a second UE and/or a rescue center.

2. The method as claimed in claim 1, wherein the first UE is in an RRC_IDLE state, an RRC_connected state, or an RRC_inactive state.

3. The method as claimed in claim 1, wherein the payload further comprises user information of the first UE, location information, indication for predefined distress message, or all.

4. The method as claimed in claim 3, further comprising:
receiving, via the core network, user information of the second UE and a distress message, before the first UE transmits the first uplink message;
wherein the emergency indicator instructs the base station to transmit the user information of the first UE and the location information to the core network, and the core network determines to transmit the emergency message to the second UE and/or the rescue center based on the user information of the first UE;
wherein the emergency message comprises the location information, the distress message, or both.

5. The method as claimed in claim 1, further comprising:
receiving, via the first UE, a first downlink message from the base station, wherein the first downlink message comprises at least one of a resource configuration for transmitting a second uplink message, a resource configuration for retransmitting the first uplink message, an acknowledgement message of the first uplink message, and an evacuation guidance;
transmitting, via the first UE, the second uplink message to the base station, when the first downlink message comprises the resource configuration for transmitting the second uplink message;
wherein the second uplink message comprises user information of the first UE, location information, or both.

6. The method as claimed in claim 1, wherein the core network transmits the emergency message to a public platform, in response to the payload not comprising user information of the first UE.

7. The method as claimed in claim 1, wherein the emergency message comprises current cell information of the first UE, historical location information of the first UE, or the information of the network that the first UE has camped on, in response to the payload not comprising location information.

8. The method as claimed in claim 1, further comprising:
transmitting, via the first UE, a third uplink message to the base station, when the first UE is in an RRC_CONNECTED state, an RRC_IDLE state, or an RRC_INACTIVE state, wherein the third uplink message comprises the emergency indicator;
receiving, via the first UE, a second downlink message from the base station, wherein the second downlink message comprises a resource configuration for transmitting a fourth uplink message and an acknowledgement message of the third uplink message; and
transmitting, via the first UE, the fourth uplink message to the base station, wherein the fourth uplink message comprises user information of the first UE, location information, or both.

9. The method as claimed in claim 8, further comprising:
receiving, via the first UE, a third downlink message from the base station;
wherein the third downlink message comprise an acknowledgement message of the fourth uplink message and a public rescue instruction message.

10. The method as claimed in claim 8, wherein the third uplink message is a buffer status report (BSR) carried in a physical uplink control channel (PUCCH).

11. The method as claimed in claim 1, further comprising:
transmitting, via the first UE, a packet to the base station when the first UE is in an RRC_CONNECTED state, wherein a layer 2 header of the packet comprises the emergency indicator along with user information of the first UE, location information, or both;
wherein the emergency indicator instructs the base station to: simplify or skip at least one message processing operation, allocate a frequency band dedicated to the packet, allocate a contention based frequency band to the packet, or transmit the packet with a higher priority.

12. The method as claimed in claim 1, further comprising:
connecting, via the first UE, to a third UE; and
transmitting, via the first UE, a first message to the base station through the third UE, wherein the first message comprises the emergency indicator along with user information of the first UE, location information, or both.

13. The method as claimed in claim 12, wherein the third UE receives a plurality of messages from a plurality of UEs and transmits a combined message to the base station;
wherein each of the plurality of messages comprises the emergency indicator along with user information of one of a plurality of UEs or location information;
wherein the combined message comprises the first message and the plurality of messages.

14. An electronic device, acting as a first user device (UE), wherein the electronic device comprises:
a transceiver; and
a processing circuit, configured to:
perform a 2-step random access procedure;
transmit a first uplink message in the 2-step random access procedure to a base station through the transceiver, wherein the first uplink message comprises a preamble and a payload, wherein the payload comprises an emergency indicator;
wherein the emergency indicator instructs the base station to inform a core network to transmit an emergency message to a second UE, and/or a rescue center.

15. The electronic device as claimed in claim 14, wherein the first UE is in an RRC_IDLE state, an RRC_CONNECTED state, or an RRC_inactive state.

16. The electronic device as claimed in claim 14, wherein the payload further comprises user information of the first UE, location information, indication for predefined distress message, or all.

17. The electronic device as claimed in claim 14, wherein the processing circuit is further configured to:
receive a first downlink message from the base station through the transceiver, wherein the first downlink message comprises at least one of a resource configuration for transmitting a second uplink message, a resource configuration for retransmitting the first uplink message, and an acknowledgement message of the first uplink message;
transmit the second uplink message to the base station, when the first downlink message comprises the resource configuration for transmitting the second uplink message;
wherein the second uplink message comprises user information of the first UE, location information, or both.

18. The electronic device as claimed in claim 14, wherein the emergency message comprises current cell information of the first UE, historical location information of the first UE, or the information of the network that the first UE has camped on, in response to the payload not comprising location information.

19. The electronic device as claimed in claim 14, wherein the processing circuit is further configured to:
transmit a third uplink message to the base station through the transceiver, when the first UE is in an RRC_CONNECTED state, an RRC_IDLE state, or an RRC_INACTIVE state, wherein the third uplink message comprises the emergency indicator;
receive a second downlink message from the base station through the transceiver, wherein the second downlink message comprises the resource configuration for transmitting a fourth uplink message and an acknowledgement message of the third uplink message; and
transmit the fourth uplink message to the base station through the transceiver, wherein the fourth uplink message comprises user information of the first UE, location information, or both.

20. The electronic device as claimed in claim 14, wherein the processing circuit is further configured to:
connect to a third UE; and
transmit a first message to the base station through the third UE via the transceiver, wherein the first message comprises the emergency indicator along with user information of the first UE, location information, or both.
